(19) United States
(12) Patent Application Publication
(10) Pub. No.: US 2025/0165519 A1
(43) Pub. Date: May 22, 2025

(54) METHOD FOR GENERATING PRESENTATION DOCUMENT, DEVICE AND MEDIUM

(71) Applicant: Beijing Zitiao Network Technology Co., Ltd., Beijing (CN)

(72) Inventor: Qing ZENG, Beijing (CN)

(21) Appl. No.: 18/954,247

(22) Filed: Nov. 20, 2024

(30) Foreign Application Priority Data
Nov. 21, 2023 (CN) 202311560869.7

(51) Int. Cl. G06F 16/40; G06F 40/106; G06F 40/35

(52) U.S. Cl. CPC G06F 16/40; G06F 40/106; G06F 40/35

(57) ABSTRACT

A method for generating a presentation document, a device, and a medium are provided. The method includes: in response to receiving a theme of the presentation document in a dialog component of a presentation document page, replying with an outline content in the dialog component; and in response to receiving a determination instruction for a style of the presentation document in the dialog component, generating a target presentation document based on the outline content of the presentation document and the style of the presentation document. The dialog component is configured to receive and reply to a message, the outline content includes a content heading and/or descriptive information for the content heading and the outline content is generated based on the theme of the presentation document.

### CROSS-REFERENCE TO RELATED APPLICATION

The present application claims priority of the Chinese Patent Application No. 202311560869.7, filed Nov. 21, 2023, the disclosure of which is incorporated herein by reference in its entirety as part of the present application.

### TECHNICAL FIELD

Embodiments of the present disclosure relate to the field of computer technology, and in particular to a method for generating a presentation document, a device and a medium.

### BACKGROUND

A presentation document usually includes text and images to illustrate the product or the theme that the presenter needs to demonstrate. In the process of editing the presentation document, the editor is required to input text, images, and other materials, and edit and layout the material. Editing the presentation document is complicated and time-consuming, and it is less efficient to generate the presentation document.

### SUMMARY

In view of this, embodiments of the present disclosure provides a method and an apparatus for generating a presentation document, a device and a medium.

In view of this, the present disclosure provides the following technical solutions:

At least one embodiment of the present disclosure provides a method for generating a presentation document, which includes:
in response to receiving a theme of a presentation document in a dialog component of a presentation document page, replying with an outline content in the dialog component, where the outline content is generated based on the theme of the presentation document, the outline content includes a content heading and/or descriptive information for the content heading, and the dialog component is configured to receive and reply to a message; and
in response to receiving a determination instruction for a style of the presentation document in the dialog component, generating a target presentation document based on the outline content of the presentation document and the style of the presentation document.

In a possible implementation, receiving a theme of a presentation document in a dialog component of a presentation document page, includes:

receiving a message including the theme sent by a user in the dialog component of the presentation document page.

In a possible implementation, the method further includes:
replying with a theme message in the dialog component, where the theme message includes a candidate theme;
receiving a theme of a presentation document in a dialog component of a presentation document page, including:
receiving a selection instruction for the theme of the presentation document in the dialog component of the presentation document page.

In a possible implementation, the method further includes:

displaying a message including the theme of the presentation document sent by a user in the dialog component.

In a possible implementation, the method further includes:
replying with a style message in the dialog component, where the style message includes a to-be-determined style of the presentation document, the to-be-determined style of the presentation document is a candidate style;
in response to receiving a determination instruction for a style of the presentation document in the dialog component, including:
in response to receiving a selection instruction for the style of the presentation document in the dialog component, where the style of the presentation document belongs to the candidate style.

In a possible implementation, the candidate style matches the theme.

In a possible implementation, the method further includes:

in response to receiving a re-generation instruction for the outline content in the dialog component, displaying a new outline content in the dialog component.

In a possible implementation, the method further includes:
in response to receiving an edit instruction for the outline content in the dialog component, presenting the outline content in a session input area of the dialog component for editing by a user; and
in response to receiving an edited outline content, generating a new outline content based on the edited outline content, and replying with the new outline content in the dialog component.

In a possible implementation, the method further includes:

in response to receiving an outline confirmation instruction in the dialog component, replying with a style message in the dialog component, where the outline confirmation instruction is a text dialog message, and the style message includes a to-be-determined style of the presentation document.

In a possible implementation, after generating a target presentation document based on the outline content of the presentation document and the style of the presentation document, the method further includes:
replying with an edit message for the target presentation document in the dialog component, where the edit message includes at least one edit control; and
in response to receiving a trigger operation on the edit control, adjusting the target presentation document.

In a possible implementation, the edit control includes an image control and/or a style control; the image control is configured to output an image content in the dialog component based on a user input, the style control is configured to adjust a style of the target presentation document in response to the user input.

In a possible implementation, the target presentation document includes a template content, and the template content is obtained by expanding the outline content.

In a possible implementation, the template content is obtained by processing the outline content by a first natural language processing model.

In a possible implementation, the outline content is obtained by processing the theme of the presentation document by a second natural language processing model.

In a possible implementation, the target presentation document is generated by processing the style of the presentation document and the outline content of the presentation document by an artificial intelligence model.

At least one embodiment of the present disclosure provides an apparatus for generating a presentation document, which includes:
a first interaction unit, which is configured to reply with the outline content in the dialog component in response to receiving a theme of a presentation document in a dialog component of a presentation document page, where the outline content is generated based on the theme of the presentation document, the outline content includes a content heading and/or descriptive information of the content heading, and the dialog component is configured to receive and reply to a message; and
a generation unit, which is configured to generate a target presentation document based on the outline content of the presentation document and a style of the presentation document in response to receiving a determination instruction in the dialog component for the style of the presentation document.

In a possible implementation, the first interaction unit, which is configured to in response to receiving the theme of the presentation document in the dialog component of the presentation document page, includes:

the first interaction unit, which is configured to in response to receiving a message including the theme sent by a user in the dialog component of the presentation document page.

In a possible implementation, the apparatus further includes:
a second interaction unit, which is configured to reply with the theme message in the dialog component, the theme message including a candidate theme; and
the first interaction unit, which is configured to in response to receiving the theme of the presentation document in the dialog component of the presentation document page, including:

the first interaction unit, which is configured to in response to receiving a selection instruction for the theme of the presentation document in the dialog component of the presentation document page.

In a possible implementation, the apparatus further includes:

a third interaction unit, which is configured to display a message including the theme of the presentation document sent by the user in the dialog component.

In a possible implementation, the apparatus further includes:
a fourth interaction unit, which is configured to reply with a style message in the dialog component. The style message includes a to-be-determined style of the presentation document, and the to-be-determined style of the presentation document is a candidate style; and
the generation unit, which is configured to in response to receiving the determination instruction for the style of the presentation document in the dialog component, including:
which is configured to in response to receiving a selection instruction for the style of the presentation document in the dialog component. The style of the presentation document belongs to the candidate style.

In a possible implementation, the candidate style matches the theme.

In a possible implementation, the apparatus further includes:

a fifth interaction unit, which is configured to display a new outline content in the dialog component in response to receiving a re-generation instruction for the outline content in the dialog component.

In a possible implementation, the apparatus further includes:
a first edit unit, which is configured to present the outline content in the session input area of the dialog component for the user to edit in response to receiving an edit instruction for the outline content in the dialog component; and
a sixth interaction unit, which is configured to generate a new outline content based on the edited outline content in response to receiving the edited outline content, and reply with the new outline content in the dialog component.

In a possible implementation, the apparatus further includes:

a seventh interaction unit, which is configured to reply with the style message in the dialog component in response to receiving an outline confirmation instruction in the dialog component. The outline confirmation instruction is a text dialog message. The style message includes a to-be-determined style of the presentation document.

In a possible implementation, the apparatus further includes:
a second edit unit, which is configured to reply with the edit message for the target presentation document in the dialog component. The edit message includes at least one edit control; and
an adjustment unit, which is configured to adjust the target presentation document in response to receiving a trigger operation on the edit control.

In a possible implementation, the edit control includes an image control and/or a style control; the image control is configured to output image content in the dialog component based on a user input, and the style control is configured to adjust a style of the target presentation document in response to the user input.

In a possible implementation, the target presentation document includes a template content. The template content is obtained by extending the outline content.

In a possible implementation, the template content is obtained by processing the outline content by a first natural language processing model.

In a possible implementation, the outline content is obtained by processing the theme of the presentation document by a second natural language processing model.

In a possible implementation, the target presentation document is generated by processing the style of the presentation document and the outline content of the presentation document by an artificial intelligence model.

At least one embodiment of the present disclosure provides an electronic device, which includes:
at least one processor; and
at least one memory storing one or more programs,
where the one or more programs upon being executed by the at least one processor, causes the at least one processor to implement the method for generating the presentation document provided by at least one of the above embodiments.

At least one embodiment of the present disclosure provides a non-transitory computer-readable storage medium, which stores computer programs, where the computer programs upon being executed by a processor implement the method for generating the presentation document provided by at least one of the above embodiments.

At least one embodiment of the present disclosure provides a computer program product, the computer program product when performed on a device, causes the device to implement the method for generating the presentation document provided by at least one of the above embodiments.

### BRIEF DESCRIPTION OF DRAWINGS

FIG. 1 is a schematic diagram of an interaction scene for generating a presentation document provided by an embodiment of the present disclosure;

FIG. 2 is a schematic diagram of another interaction scenario for generating a presentation document provided by an embodiment of the present disclosure;

FIG. 3 is a schematic diagram of another interaction scenario for generating a presentation document provided by an embodiment of the present disclosure;

FIG. 4 is a schematic diagram of another interaction scenario for generating a presentation document provided by an embodiment of the present disclosure;

FIG. 5 is a flowchart of a method for generating a presentation document provided by an embodiment of the present disclosure;

FIG. 6 is a schematic diagram of an interaction control provided by an embodiment of the present disclosure;

FIG. 7 is a schematic diagram of a dialog component provided by an embodiment of the present disclosure;

FIG. 8 is a schematic diagram of another dialog component provided by an embodiment of the present disclosure;

FIG. 9 is a schematic diagram of a prompt text provided by an embodiment of the present disclosure;

FIG. 10 is a schematic diagram of a prompt message provided by an embodiment of the present disclosure;

FIG. 11 is a schematic diagram of a theme message provided by an embodiment of the present disclosure;

FIG. 12 is a schematic diagram of yet another dialog component provided by an embodiment of the present disclosure;

FIG. 13 is a schematic diagram of a style message provided by an embodiment of the present disclosure;

FIG. 14 is a schematic diagram of another style message provided by an embodiment of the present disclosure;

FIG. 15 is a schematic diagram of a dialog component provided by an embodiment of the present disclosure;

FIG. 16 is a schematic diagram of another dialog component provided by an embodiment of the present disclosure;

FIG. 17 is a schematic diagram of a replied message of an outline content provided by an embodiment of the present disclosure;

FIG. 18 is a schematic diagram of a dialog component provided by an embodiment of the present disclosure;

FIG. 19 is a schematic diagram of an edit message provided by an embodiment of the present disclosure;

FIG. 20 is a structural schematic diagram of an apparatus for generating a presentation document provided by an embodiment of the present disclosure;

FIG. 21 is a structural schematic diagram of an electronic device provided by an embodiment of the present disclosure.

### DETAILED DESCRIPTION

In order to facilitate the understanding and explanation of the technical solutions provided by the embodiments of the present disclosure, the background technology of the present disclosure is first described below.

In the process of editing a presentation document, an editor is required to first compose texts, and collect images to accompany the texts and other materials. The editor selects a presentation document template, inputs the text, images, and other materials into the presentation document template, and then performs editing operations such as laying out the materials and setting a display mode to generate the presentation document. The process of editing the presentation document by the editor is more complicated, and the efficiency of editing the presentation document is lower, requiring the editor to spend a lot of time.

Based on the above, embodiments of the present disclosure provide a method and an apparatus for generating a presentation document, a device, and a medium. In the method, in response to receiving a theme of a presentation document in a dialog component of a presentation document page, replying with an outline content in the dialog component; in response to receiving a determination instruction for a style of the presentation document in the dialog component, generating a target presentation document based on the outline content of the presentation document and the style of the presentation document. The dialog component is configured to receive and reply to a message, the outline content includes a content heading and/or descriptive information for the content heading and the outline content is generated based on the theme of the presentation document. In this way, the presentation document can be automatically generated interactively based on the theme and style of the presentation document determined by the user, which improves the efficiency of generating the presentation document and reduces the time cost of generating the presentation document. Moreover, the generated presentation document is of high quality and can meet the user's needs.

In order to facilitate understanding of a method for generating a presentation document provided by an embodiment of the present disclosure, the method for generating the presentation document provided by the embodiment of the present disclosure is described below in connection with the drawing and is described below in connection with the example scenarios shown in FIG. 1-FIG. 4. FIG. 1-FIG. 4 are schematic diagrams of an exemplary application scenario provided by an embodiment of the present disclosure.

It is understood by those skilled in the art that the schematic diagrams shown in FIG. 1-FIG. 4 are only examples in which the embodiments of the present disclosure may be realized. The scope of application of the embodiments of the present disclosure is not limited by any aspect of the scenarios shown in the schematic diagrams.

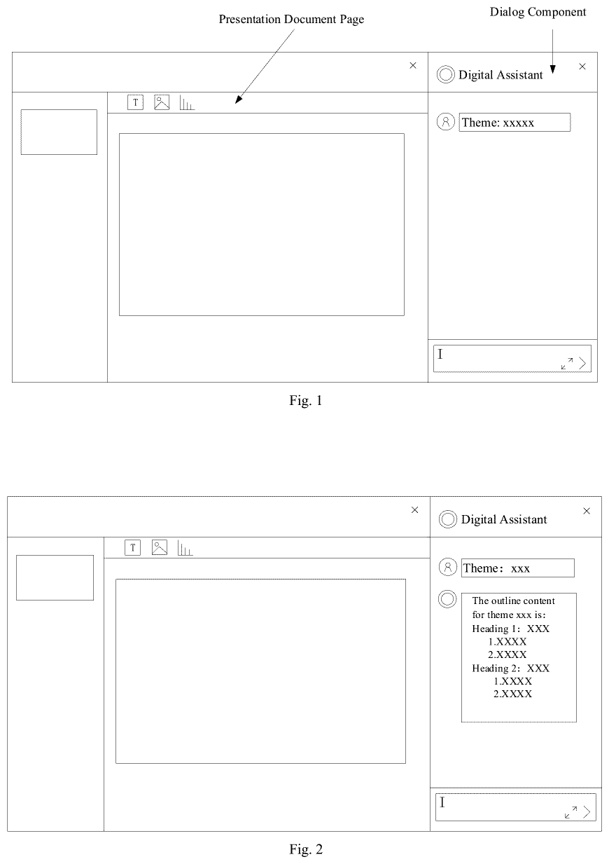

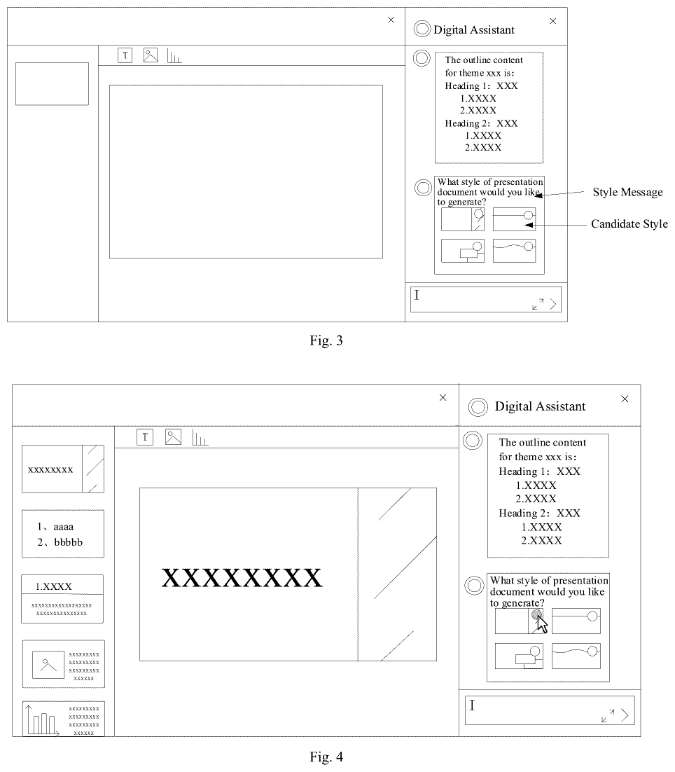

The method for generating the presentation document provided by the embodiments of the present disclosure may be applied to a client. As an example, refer to FIG. 1, which shows a dialog component displayed on a presentation document page of the client. A user may interact with a robot, such as a digital assistant, with messages via the dialog component. The user sends a theme of the presentation document in the dialog component. For example, sending a message including the theme of the presentation document. Referring to FIG. 2, the client displays the outline content of the digital assistant's reply in the dialog component in response to receiving the theme of the presentation document in the dialog component. The outline content is generated based on the theme of the presentation document. The outline content includes one or more of a content heading and descriptive information for the content heading. The outline content may form a framework for the content of the presentation document. The outline content may be viewed by the user in the dialog component. The user may also trigger a determination instruction in the dialog component for the style of the presentation document. For example, referring to FIG. 3, a style message is replied with in the dialog component. The style message includes a candidate style. The user may trigger a determination instruction for the style of the presentation document in the dialog component. The client generates a target presentation document in response to the determination instruction for the style of the presentation document received in the dialog component. As shown in FIG. 4, the client displays the target presentation document on the presentation document page. The user may use the generated target presentation document directly or make simple adjustments to the content based on the generated target presentation document to obtain a usable presentation document. This reduces the time required to generate the presentation document, and makes it easier for the user to edit the presentation document.

To facilitate understanding of the technical solutions provided by the embodiments of the present disclosure, the method for generating the presentation document provided by the embodiments of the present disclosure is described below in connection with the drawings.

It is first described that the method for generating the presentation document provided by the embodiments of the present disclosure may be applied to a client. The client is, for example, an application installed on a device, or a browser.

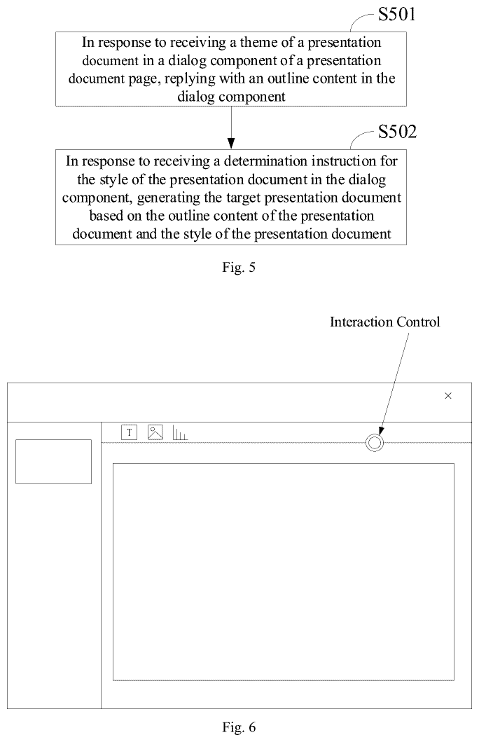

Referring to FIG. 5, which is a flowchart of a method for generating a presentation document provided by embodiments of the present disclosure. As shown in FIG. 5, the method may include S501-S502.

S501: in response to receiving a theme of a presentation document in a dialog component of a presentation document page, replying with an outline content in the dialog component.

The presentation document page is used to edit and display the presentation document. The dialog component of the presentation document page is configured to receive and reply to a message. The user may interact with the digital assistant to enable editing of the presentation document based on the dialog component. The interaction message sent by the digital assistant is, for example, capable of being generated by an artificial intelligence model, such as a natural language processing model, processing the interaction message input by the user.

The embodiments of the present disclosure do not limit the implementations of how the display of the dialog component is triggered. For example, an interaction control is displayed on the presentation document page. The interaction control is displayed, for example, in the style of a logo of a robot. Referring to FIG. 6, the dialog component is displayed by the user triggering the interaction control. As another example, the dialog component is displayed in response to displaying the presentation document page.

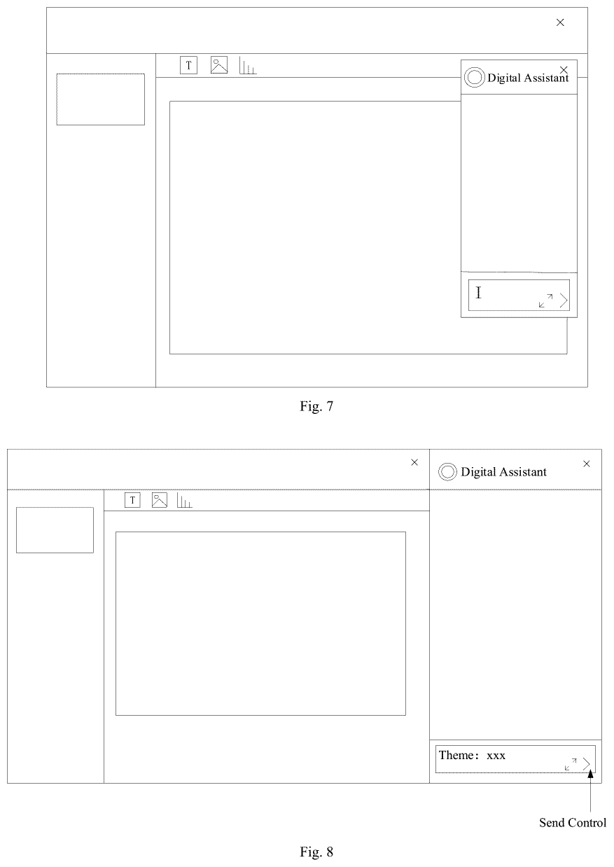

The embodiments of the present disclosure also do not limit the display manners of the dialog component. For example, as shown in FIG. 7, the dialog component may be a component that is displayed at a display level higher than the presentation document page, that is, the dialog component is displayed suspended at the display level above the display level of the presentation document page. Or, for another example, as shown in FIG. 1, the dialog component is displayed side-by-side with the presentation document page on the client's display screen.

The user may send the theme of the presentation document in the dialog component. The theme of the presentation document is the theme of the text content of the presentation document that the user needs to generate. The theme of the presentation document is, for example, the theme of a weekly report, a product analysis report, a personal summary, and the like.

The embodiments of the present disclosure do not limit possible implementations of receiving the theme of the presentation document in the dialog component.

In a possible implementation, the dialog component includes a session input area. The user inputs a message whose content is a theme trough the session input area of the dialog component, and sends the message that includes the theme of the presentation document. Referring to FIG. 8, the user may click on a send control included in the dialog component to trigger a send instruction for the message that includes the theme of the presentation document.

In response to obtaining the send instruction for the message including the theme, the message including the theme of the presentation document sent by the user is displayed in the dialog component. As an example, refer to the dialog component shown in FIG. 1, which receives the theme of the presentation document by receiving the message including the theme of the presentation document.

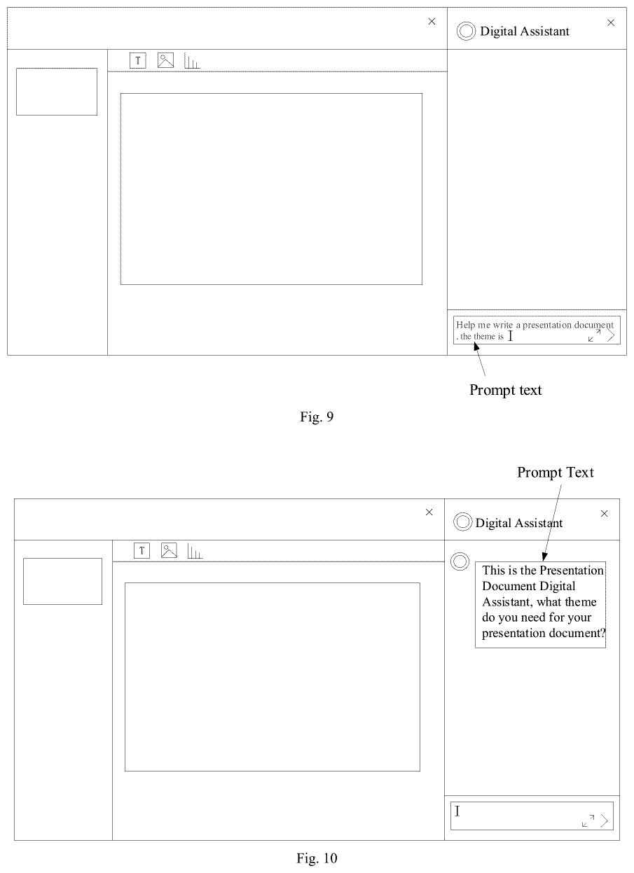

It is noted that the dialog component also displays a message used to prompt the user to perform an operation for inputting the theme. As an example, FIG. 9 shows that before the user inputs the message based on the session input area, a prompt text “Help me write a presentation document, the theme is” is displayed in the session input area to prompt the user to input the theme. As another example, refer to FIG. 10, a prompt message sent by the digital assistant is displayed in the dialog component. The prompt message is used to prompt the user to input the theme. The prompt message may be, for example, “This is the Presentation Document Digital Assistant, what theme do you need for your presentation document?”.

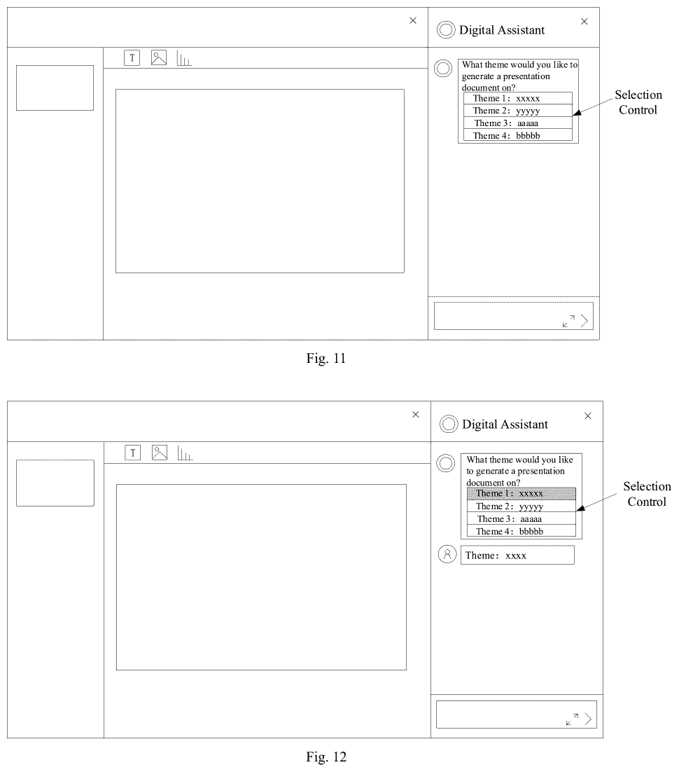

In another possible implementation, the theme message sent by the digital assistant is displayed in the dialog component. The theme message includes a candidate theme. Referring to FIG. 11, the theme message may be displayed in the form of a message card. The message card includes a prompt text for prompting the user to select and selection controls for each of candidate themes. The user may trigger the selection control for the theme to be selected, triggering a selection instruction for the theme of the presentation document. The candidate theme may be a preset theme or a theme with a use probability greater than a threshold. The theme of the presentation document is received by receiving a selection instruction for the theme of the presentation document.

In some possible scenarios, in response to a user triggering the selection instruction for selecting the theme of the presentation document, a message including the theme of the presentation document sent by the user is displayed in the dialog component. Based on the message card shown in FIG. 11, for example, when the user selects ‘Theme 1: xxxxx’, as shown in FIG. 12, a message sent by the user, which includes the theme of ‘xxxxx’, is displayed in dialog component. This improves the user interaction experience.

The outline content is generated based on the theme of the presentation document received. The outline content includes one or more of a content heading and descriptive information of the content heading. The descriptive information of the content heading is used to describe the content included in the content heading. The outline content may reflect a textual framework of the presentation document. The embodiments of the present disclosure do not limit the manner of generating the outline content. As an example, the outline content is generated by processing the theme by a natural language processing model. The natural language processing model may be a model pre-trained to output the outline content based on the input theme.

In response to receiving the theme of the presentation document in the dialog component of the presentation document page, the outline content is replied with in the dialog component, as shown in FIG. 2. It makes it easier for the user to check whether the generated outline content satisfies the needs of generating the presentation document.

S502: in response to receiving a determination instruction for the style of the presentation document in the dialog component, generating the target presentation document based on the outline content of the presentation document and the style of the presentation document.

The style of the presentation document is the design style of the elements included in the presentation document such as the background, colors, and images of the presentation document.

The user may trigger the determination instruction for the style of the presentation document in the dialog component to realize the selection of the style to be used for the target presentation document.

The embodiments of the present disclosure do not limit possible implementations of receiving the determination instruction for the style of the presentation document in the dialog component.

In a possible implementation, the style of the presentation document is a pre-determined template style, a style that matches a theme determined based on the theme of the presentation document, or a style generated by an image processing model based on theme processing. The image processing model is an image model pre-trained to generate the style based on the theme of the input text.

The style of the presentation document is displayed in the dialog component. The user may trigger a determination instruction for the style of the presentation document in the dialog component. For example, a style message is replied with in the dialog component. The style message includes a style of the presentation document to be determined. The user may send a determination message to trigger the determination instruction for the style of the presentation document. Alternatively, the style message is displayed in the form of a message card, which includes an application control. The user triggers the application control to trigger the determination instruction for the style of the presentation document.

In a possible implementation, the user may select the style of the presentation document. The determination instruction for the style of the presentation document is a selection instruction for the style of the presentation document.

After replying with the outline content, the style message is also replied with in the dialog component. The style message includes a style of the presentation document to be determined. As an example, the to-be-determined style of the presentation document is a plurality of candidate styles. The candidate style is, for example, a preset template style. The candidate style is, for example, a style determined from the preset template style that match the theme. As an example, the style message includes an image of the candidate style, or includes descriptive text of the candidate style.

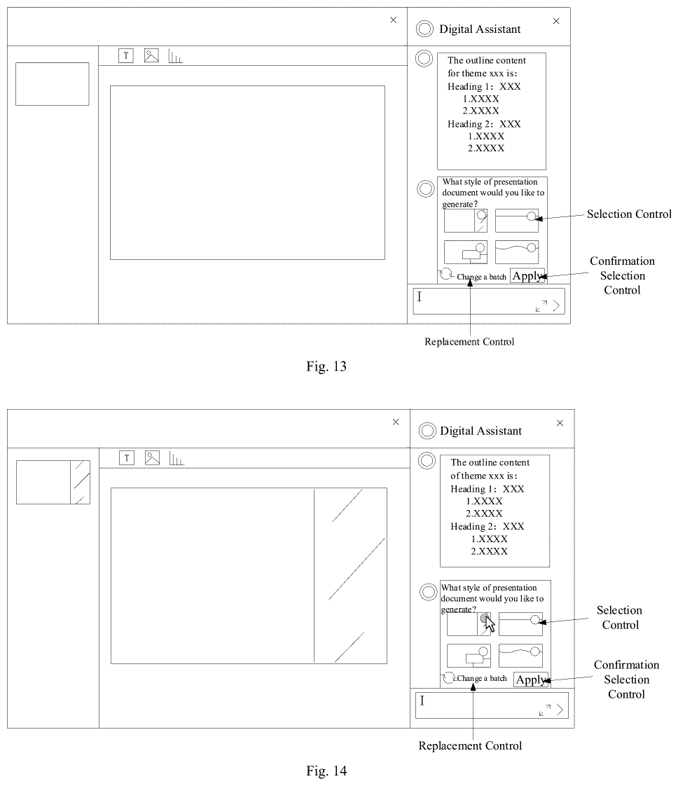

The embodiments of the present disclosure do not limit the manner of the display of the style message. In some possible implementations, refer to FIG. 13, the style message, for example, is displayed in the form of a message card. Each candidate style corresponds to a selection control. The user may trigger a selection instruction for the style of the presentation document by triggering the selection control and the confirmation selection control.

As an example, referring to FIG. 14, in response to the user triggering a click on the selection control corresponding to a certain candidate style, an image of the candidate style is displayed on the presentation document page. It makes it easier for the user to view the image of the candidate style in detail on the presentation document page and select the desired style.

In another possible implementation, taking the example of the candidate style being displayed using the descriptive text, the user may also trigger the selection instruction for the style of the presentation document by sending a message with the descriptive text of the style of the presentation document.

In some possible scenarios, only a certain number of candidate styles may be included in the candidate styles displayed in the dialog component. As an example, the message sent by the digital assistant is displayed in the form of a message card. The message card also includes a replacement control. As shown in FIG. 14, the replacement control is, for example, a control that displays a “new batch” text. The user triggers the replacement control to replace the candidate style displayed in the message card. As another example, the user may trigger the display of a new candidate style in the dialog component by sending a message indicating the semantics of the re-replacement. It enriches the number of candidate styles available to the user and makes it easier for the user to select the appropriate target style.

The target presentation document is generated based on the determined style of the presentation document and the outline content of the presentation document.

As an example, a trained artificial intelligence model is used to process the outline content of the presentation document and the style of the presentation document to generate the presentation document. The trained artificial intelligence model enables automatic generation of the presentation document based on the outline content of the presentation document and the style of the presentation document.

In some possible implementations, the target presentation document includes a template content. The template content is generated based on an extension of the outline content. For example, the template content is generated by expanding the outline content with descriptive information about the content heading. The template content may be generated by processing the outline content by a natural language model. As an example, after generating the target presentation document, the target presentation document is displayed on the presentation document page. For example, referring to FIG. 4, the user may view or continue editing the generated target presentation document on the presentation document page.

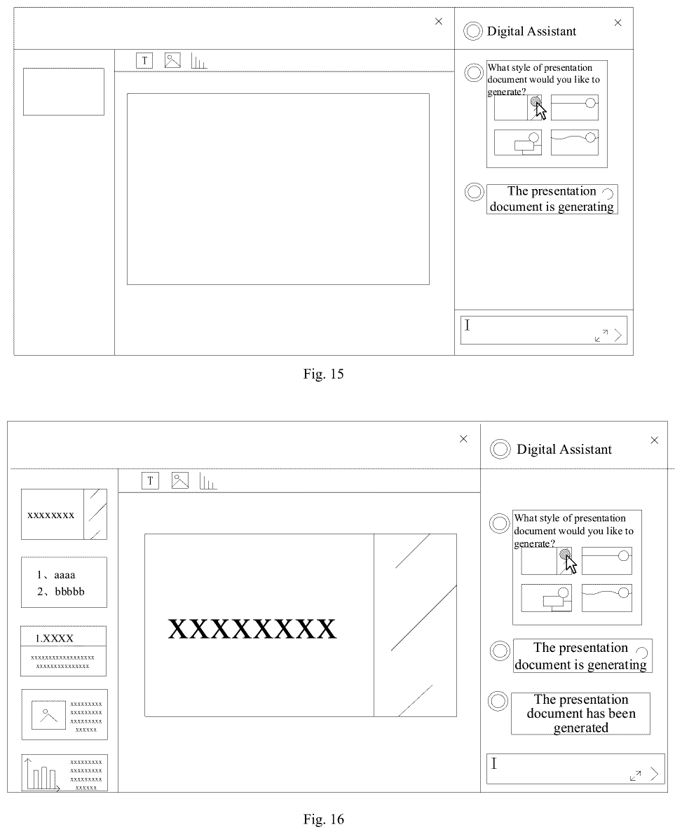

It is noted that in some possible implementations, after receiving the determination instruction for the style of the presentation document, referring to FIG. 15, a message is replied with in the dialog component for prompting that the presentation document is being generated. For example, the message includes the text “Presentation document is being generated”. It is to prompt the user that the presentation document is being generated and enriches the interactive process.

Further, after the presentation document has been generated, a message is replied with in the dialog component to indicate that the presentation document has been generated. For example, as shown in FIG. 16, the message includes the text “Presentation document has been generated”. It prompts the user that the presentation document has been generated and enhances the interactive effect.

Based on the contents of S501-S502 above, based on the theme of the presentation document determined by the user, the outline content can be automatically generated, and further, the target generation can be automatically generated based on the determined style of the presentation document. In this way, a presentation document that satisfies the needs of the user can be automatically generated, and the quality of the automatically generated presentation document can be improved. The efficiency of generating the presentation document is improved and the operation of the user in editing the presentation is reduced. In addition, generating the presentation document using interactive triggers improves the user experience of editing the presentation document.

In some possible implementations, the user may confirm or edit the replied outline content.

In addition to the above steps, the method for generating the presentation document provided by the embodiments of the present disclosure, after replying with the outline content in the dialog component, further includes the following steps:

in response to receiving an outline confirmation instruction in the dialog component, replying with a style message in the dialog component.

The user may confirm whether the presentation document is generated based on the outline content after viewing the displayed outline content. Upon confirmation, the user triggers a confirmation instruction for the outline content.

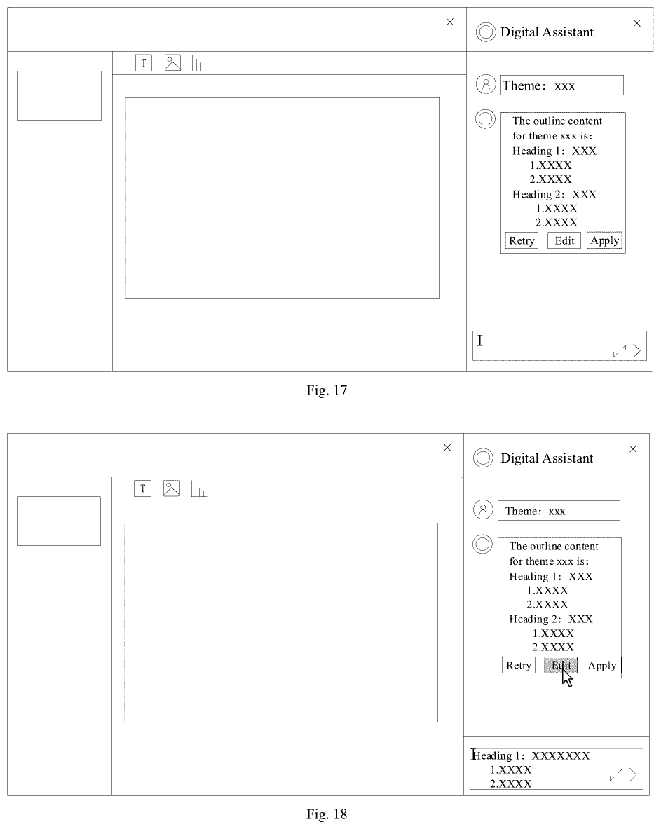

The embodiments of the present disclosure do not limit the implementations of triggering the confirmation instruction for the outline content. As an example, the replied message of the outline content further includes an application control for the outline content. By triggering the application control, the confirmation instruction specific to the outline content is triggered. For example, as shown in FIG. 17, the replied message of the outline content in the dialog component is displayed in the form of a message card that includes the application control. The user may trigger the confirmation instruction for the outline content by triggering the application control. As another example, the user may trigger the confirmation instruction for the outline content by sending a confirmation message in the dialog component. As another example, when it is detected that the deletion or modification instruction for the outline content has not been obtained within a preset time period, the confirmation instruction for the outline content is triggered.

In some possible implementations, the outline confirmation instruction is a text dialog message. In response to receiving the outline confirmation instruction in the dialog component, a style message is replied with in the dialog component. The style message includes a to-be-determined style of the presentation document. The user may send a determination instruction for the style of the presentation document in the dialog component based on the style message. The specific process is described in S502 and will not be repeated herein.

In addition, in some cases, the user may need to adjust the outline content after viewing the outline content.

For example, the user may trigger a re-generation of the outline content. In addition to the above steps, the method for generating the presentation document provided by the embodiments of the present disclosure, after replying with the outline content in the dialog component, further includes:
in response to receiving a re-generation instruction for the outline content in the dialog component; and
displaying a new outline content in the dialog component.

As an example, the re-generation instruction for the outline content is a message triggered by the user in the dialog component indicating the semantics of the re-replacement. As another example, the replied outline content in the dialog component is displayed in the form of a message card. Referring to FIG. 17, the message card includes a retry control. By triggering the retry control, the user triggers the re-generation instruction for generating the outline content in the dialog component.

In response to receiving the re-generation instruction for the outline content, the new outline content is displayed in the dialog component. The new outline content may be regenerated based on the theme by a natural language processing model.

The new outline content may be displayed in the same manner as the historical replied outline content. As an example, in the dialog component, a message including the outline content sent by the digital assistant is displayed.

In addition, in some cases, the user may need to edit the outline content after viewing the outline content. In addition to the above steps, the method for generating the presentation document provided by the embodiments of the present disclosure includes the following steps after replying with the outline content in the dialog component:
in response to receiving an edit instruction for the outline content in the dialog component, presenting the outline content in a session input area of the dialog component for editing by the user; and
in response to receiving an edited outline content, generating a new outline content based on the edited outline content, and replying with the new outline content in the dialog component.

As an example, the edit instruction for the outline content is a message triggered by the user in the dialog component indicating the semantics of the editing. As another example, the replied outline content in the dialog component is displayed in the form of a message card. Referring to FIG. 17, the message card includes an edit control. The user triggers the generation of an edit instruction for the outline content by triggering the edit control.

In response to receiving an edit instruction for the outline content, the outline content is displayed in the session input area of the dialog component. As an example, referring to FIG. 18 for an illustration. In this way, it is convenient for the user to modify the outline content in the session input area. In some possible implementations, the session input area is displayed in a full-screen display to facilitate the user in editing the outline content.

After editing the outline content, the user may send the edited outline content in the dialog component. In response to receiving the edited outline content, a new outline content is generated by the edited outline content. The new outline content may be the edited outline content or an adjusted outline content based on the edited outline content. As an example, the edited outline content is input into a natural language model to obtain the output new outline content.

The new outline content is replied with in the dialog component, which makes it easy for the user to view the new outline content. In some possible implementations, it is also possible to adjust the target presentation document after generating the target presentation document. The embodiments of the present disclosure provide a method for generating a presentation document including, in addition to the above steps, the following steps:
replying with an edit message for the target presentation document in the dialog component, the edit message including at least one edit control; and
adjusting the target presentation document in response to receiving a trigger operation on the edit control.

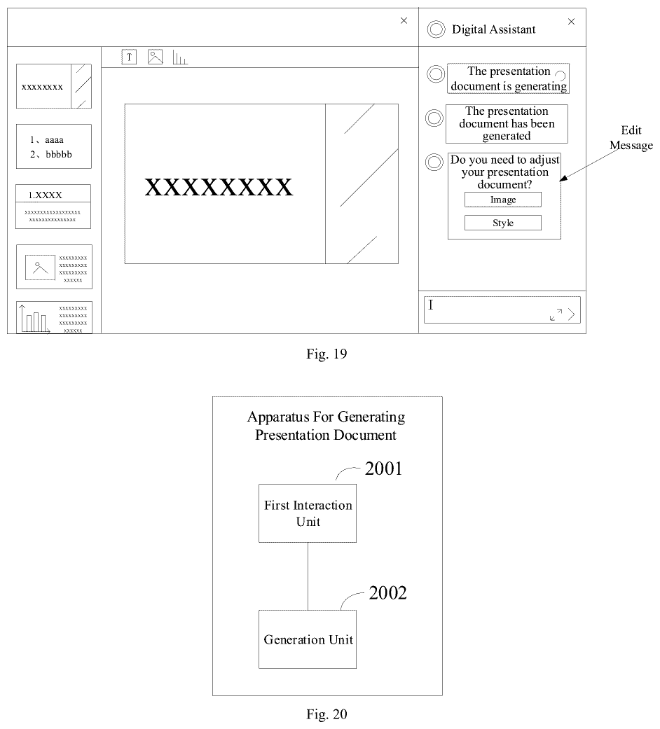

The edit message is for prompting the user to make further edits to the presentation document. The edit message includes at least one edit control. Different edit controls correspond to different editing functions. As an example, the edit control includes at least one of an image control and a style control. Referring to FIG. 19, the edit message includes an image control and a style control. The image control is for outputting image content in the dialog component based on user input. The image content may be used to adjust an image included in the target presentation document. As an example, the image content may be obtained by processing a text message input by the user using an image generation model. The style control is for adjusting the style of the target presentation document in response to the user input.

The user may trigger the edit control to edit the target presentation document. The target presentation document is adjusted in response to receiving a trigger operation on the edit control. Take the example of triggering the image control to adjust an image in the target presentation document. For example, replace the image in the target presentation document. Take the example of triggering the style control to adjust the style of the target presentation document. It facilitates automatic adjustment of the presentation document based on user needs and improves the efficiency of editing the presentation document.

Based on the method for generating the presentation document provided by the above method embodiments, the embodiments of the present disclosure also provide an apparatus for generating a presentation document, and the apparatus for generating the presentation document is be described below in connection with the drawings.

FIG. 20 shows a structural schematic diagram of an apparatus for generating a presentation document provided by the embodiments of the present disclosure. As shown in FIG. 20, the apparatus for generating the presentation document includes:
a first interaction unit 2001, which is configured to reply with the outline content in the dialog component in response to receiving a theme of a presentation document in a dialog component of a presentation document page, where the outline content is generated based on the theme of the presentation document, the outline content includes a content heading and/or descriptive information of the content heading, and the dialog component is configured to receive and reply to a message; and
a generation unit 2002, which is configured to generate a target presentation document based on the outline content of the presentation document and a style of the presentation document in response to receiving a determination instruction in the dialog component for the style of the presentation document.

In a possible implementation, the first interaction unit 2001, which is configured to in response to receiving the theme of the presentation document in the dialog component of the presentation document page, includes:

the first interaction unit 2001, which is configured to in response to receiving a message including the theme sent by a user in the dialog component of the presentation document page.

In a possible implementation, the apparatus further includes:
a second interaction unit, which is configured to reply with the theme message in the dialog component, the theme message including a candidate theme; and
the first interaction unit 2001, which is configured to in response to receiving the theme of the presentation document in the dialog component of the presentation document page, including:

the first interaction unit 2001, which is configured to in response to receiving a selection instruction for the theme of the presentation document in the dialog component of the presentation document page.

In a possible implementation, the apparatus further includes:

a third interaction unit, which is configured to display a message including the theme of the presentation document sent by the user in the dialog component.

In a possible implementation, the apparatus further includes:
a fourth interaction unit, which is configured to reply with a style message in the dialog component. The style message includes a to-be-determined style of the presentation document, and the to-be-determined style of the presentation document is a candidate style; and
the generation unit 2002, which is configured to in response to receiving the determination instruction for the style of the presentation document in the dialog component, including:
the generation unit 2002, which is configured to in response to receiving a selection instruction for the style of the presentation document in the dialog component. The style of the presentation document belongs to the candidate style.

In a possible implementation, the candidate style matches the theme.

In a possible implementation, the apparatus further includes:

a fifth interaction unit, which is configured to display a new outline content in the dialog component in response to receiving a re-generation instruction for the outline content in the dialog component.

In a possible implementation, the apparatus further includes:
a first edit unit, which is configured to present the outline content in the session input area of the dialog component for the user to edit in response to receiving an edit instruction for the outline content in the dialog component; and
a sixth interaction unit, which is configured to generate a new outline content based on the edited outline content in response to receiving the edited outline content, and reply with the new outline content in the dialog component.

In a possible implementation, the apparatus further includes:

a seventh interaction unit, which is configured to reply with the style message in the dialog component in response to receiving an outline confirmation instruction in the dialog component. The outline confirmation instruction is a text dialog message. The style message includes a to-be-determined style of the presentation document.

In a possible implementation, the apparatus further includes:
a second edit unit, which is configured to reply with the edit message for the target presentation document in the dialog component. The edit message includes at least one edit control; and
an adjustment unit, which is configured to adjust the target presentation document in response to receiving a trigger operation on the edit control.

In a possible implementation, the edit control includes an image control and/or a style control; the image control is configured to output image content in the dialog component based on a user input, and the style control is configured to adjust a style of the target presentation document in response to the user input.

In a possible implementation, the target presentation document includes a template content. The template content is obtained by extending the outline content.

In a possible implementation, the template content is obtained by processing the outline content by a first natural language processing model.

In a possible implementation, the outline content is obtained by processing the theme of the presentation document by a second natural language processing model.

In a possible implementation, the target presentation document is generated by processing the style of the presentation document and the outline content of the presentation document by an artificial intelligence model.

Based on the method for generating the presentation document provided by the above method embodiments, the present disclosure further provides an electronic device including: at least one processor; and at least one memory having one or more programs stored thereon, when the one or more programs are executed by the at least one processor, the at least one processor implements the method for generating the presentation document as described in any of the above embodiments.

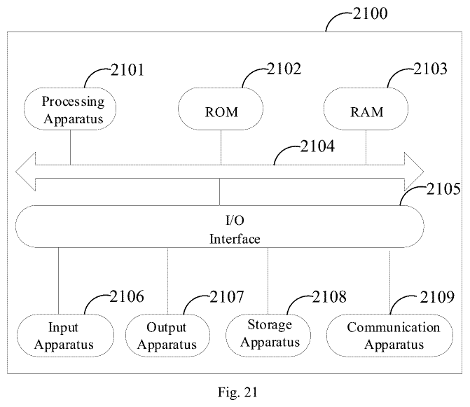

Referring to FIG. 21, FIG. 21 illustrates a structural schematic diagram of an electronic device 2100 suitable for implementing some embodiments of the present disclosure. The electronic devices in embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital television (TV), a desktop computer, or the like. The electronic device illustrated in FIG. 21 is merely an example, and should not pose any limitation to the functions and the range of use of the embodiments of the present disclosure.

As illustrated in FIG. 21, the electronic device 2100 may include a processing apparatus 2101 (e.g., a central processing unit, a graphics processing unit, etc.), which can perform various suitable actions and processing according to a program stored in a read-only memory (ROM) 2102 or a program loaded from a storage apparatus 2108 into a random-access memory (RAM) 2103. The RAM 2103 further stores various programs and data required for operations of the electronic device 2100. The processing apparatus 2101, the ROM 2102, and the RAM 2103 are interconnected by means of a bus 2104. An input/output (I/O) interface 2105 is also connected to the bus 2104.

Usually, the following apparatus may be connected to the I/O interface 2105: an input apparatus 2106 including, for example, a touch screen, a touch pad, a keyboard, a mouse, a camera, a microphone, an accelerometer, a gyroscope, or the like; an output apparatus 2107 including, for example, a liquid crystal display (LCD), a loudspeaker, a vibrator, or the like; a storage apparatus 2108 including, for example, a magnetic tape, a hard disk, or the like; and a communication apparatus 2109. The communication apparatus 2109 may allow the electronic device 2100 to be in wireless or wired communication with other devices to exchange data. While FIG. 21 illustrates the electronic device 2100 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 2109 and installed, or may be installed from the storage apparatus 2108, or may be installed from the ROM 2102. When the computer program is executed by the processing apparatus 2101, the above-mentioned functions defined in the methods of some embodiments of the present disclosure are performed.

The electronic device provided by the embodiment of the present disclosure belongs to the same inventive concept as the method for generating the presentation document provided by the above embodiments, and technical details not exhaustively described in the present embodiments can be found in the above embodiments, and the present embodiments have the same beneficial effect as the above embodiments.

Based on the method for generating the presentation document provided by the above method embodiments, an embodiment of the present disclosure provides a non-transitory computer-readable storage medium, storing computer programs, where the computer programs upon being executed by a processor implement the method for generating the presentation document as described in any of the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the method for generating the presentation document.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. The name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that, the embodiments in the specification are described in a progressive manner. Each embodiment focuses on a difference from other embodiments. For same or similar parts between embodiments, reference may be made to each other. For the apparatus embodiments, because they correspond to the method embodiments, the description is relatively simple, and reference can be made to the description of the method embodiments.

It should be understood that, in the present disclosure, ‘at least one (item)’ means one or more, and ‘more than one’ means two or more. ‘and/or’ is used to describe a relationship of the associated objects, indicating that three types of relationships may exist, for example, ‘A and/or B’ may indicate that only A exists, only B exists, and both A and B exist, where A and B may be singular or plural. The character ‘/’ generally indicates an ‘or’ relationship. The expression ‘at least one (item) of the following’ or its equivalent refers to any combination of these items, including any combination of singular or plural items. For example, at least one (item) of a, b, or c may be expressed as: a, b, c, ‘a and b’, ‘a and c’, ‘b and c’, or ‘a and b and c’, where a, b, and c may be single or multiple.

It should be noted that, in the present disclosure, the relational terms such as “first”, “second”, and the like, are only used to distinguish one entity or operation from another entity or operation, and are not intended to require or imply the existence of any actual relationship or order between these entities or operations. Furthermore, the terms “comprise/comprising”, “include/including”, or any other variations thereof are intended to cover a non-exclusive inclusion such that a process, method, article, or device that includes a list of elements includes not only those elements, but also other elements not expressly listed, or elements inherent to the process, method, article, or device. Without further limitation, an element qualified by the statement “comprises/includes a . . . ” does not exclude the presence of additional identical elements in the process, method, article, or device that includes the element.

What have been described above are only specific implementations of the present disclosure, enabling those skilled in the art to understand or implement the present disclosure. Various modifications to these embodiments are apparent to those skilled in the art, and the generic principles defined herein may be implemented in other embodiments without departing from the spirit or scope of the present disclosure. Therefore, the present disclosure is not to be limited to the embodiments herein but is intended to be accorded the widest scope consistent with the principles and novel features disclosed herein.

1. A method for generating a presentation document, comprising:
in response to receiving a theme of the presentation document in a dialog component of a presentation document page, replying with an outline content in the dialog component, wherein the outline content is generated based on the theme of the presentation document, the outline content comprises a content heading and/or descriptive information for the content heading, and the dialog component is configured to receive and reply to a message; and
in response to receiving a determination instruction for a style of the presentation document in the dialog component, generating a target presentation document based on the outline content of the presentation document and the style of the presentation document.

2. The method of claim 1, wherein the receiving the theme of the presentation document in the dialog component of the presentation document page comprises:
receiving the message comprising the theme sent by a user in the dialog component of the presentation document page.

3. The method of claim 1, further comprising:
replying with a theme message in the dialog component, wherein the theme message comprises a candidate theme,
wherein the receiving the theme of the presentation document in the dialog component of the presentation document page comprises:
receiving a selection instruction for the theme of the presentation document in the dialog component of the presentation document page.

4. The method of claim 3, further comprising:
displaying the message comprising the theme of the presentation document sent by a user in the dialog component.

5. The method of claim 1, further comprising:
replying with a style message in the dialog component, wherein the style message comprises a to-be-determined style of the presentation document, and the to-be-determined style of the presentation document is a candidate style,
wherein the receiving the determination instruction for the style of the presentation document in the dialog component comprises:
receiving a selection instruction for the style of the presentation document in the dialog component, wherein the style of the presentation document belongs to the candidate style.

6. The method of claim 5, wherein the candidate style matches the theme.

7. The method of claim 1, further comprising:
in response to receiving a re-generation instruction for the outline content in the dialog component, displaying a new outline content in the dialog component.

8. The method of claim 1, further comprising:
in response to receiving an edit instruction for the outline content in the dialog component, presenting the outline content in a session input area of the dialog component for editing by a user; and
in response to receiving an edited outline content, generating a new outline content based on the edited outline content, and replying with the new outline content in the dialog component.

9. The method of claim 1, further comprising:
in response to receiving an outline confirmation instruction in the dialog component, replying with a style message in the dialog component, wherein the outline confirmation instruction is a text dialog message, and the style message comprises a to-be-determined style of the presentation document.

10. The method of claim 1, wherein, after the generating the target presentation document based on the outline content of the presentation document and the style of the presentation document, the method further comprises:
replying with an edit message for the target presentation document in the dialog component, wherein the edit message comprises at least one edit control; and
in response to receiving a trigger operation on the edit control, adjusting the target presentation document.

11. The method of claim 10, wherein the edit control comprises an image control and/or a style control, the image control is configured to output an image content in the dialog component based on a user input, and the style control is configured to adjust the style of the target presentation document in response to the user input.

12. The method of claim 1, wherein the target presentation document comprises a template content, and the template content is obtained by expanding the outline content.

13. The method of claim 12, wherein the template content is obtained by processing the outline content by a first natural language processing model.

14. The method of claim 1, wherein the outline content is obtained by processing the theme of the presentation document by a second natural language processing model.

15. The method of claim 1, wherein the target presentation document is generated by processing the style of the presentation document and the outline content of the presentation document by an artificial intelligence model.

16. An electronic device, comprising:
at least one processor; and
at least one memory storing one or more programs,
wherein the one or more programs upon being executed by the at least one processor, causes the at least one processor to implement a method for generating a presentation document, and the method comprises:
in response to receiving a theme of the presentation document in a dialog component of a presentation document page, replying with an outline content in the dialog component, wherein the outline content is generated based on the theme of the presentation document, the outline content comprises a content heading and/or descriptive information for the content heading, and the dialog component is configured to receive and reply to a message; and
in response to receiving a determination instruction for a style of the presentation document in the dialog component, generating a target presentation document based on the outline content of the presentation document and the style of the presentation document.

17. The electronic device of claim 16, wherein the receiving the theme of the presentation document in the dialog component of the presentation document page comprises:
receiving the message comprising the theme sent by a user in the dialog component of the presentation document page.

18. The electronic device of claim 16, wherein the method further comprises:
replying with a theme message in the dialog component, wherein the theme message comprises a candidate theme,
wherein the receiving the theme of the presentation document in the dialog component of the presentation document page comprises:
receiving a selection instruction for the theme of the presentation document in the dialog component of the presentation document page.

19. The electronic device of claim 18, wherein the method further comprises:
displaying the message comprising the theme of the presentation document sent by a user in the dialog component.

20. A non-transitory computer-readable storage medium, storing computer programs, wherein the computer programs upon being executed by a processor implement a method for generating a presentation document, and the method comprises:
in response to receiving a theme of the presentation document in a dialog component of a presentation document page, replying with an outline content in the dialog component, wherein the outline content is generated based on the theme of the presentation document, the outline content comprises a content heading and/or descriptive information for the content heading, and the dialog component is configured to receive and reply to a message; and
in response to receiving a determination instruction for a style of the presentation document in the dialog component, generating a target presentation document based on the outline content of the presentation document and the style of the presentation document.
